(19) United States
(12) Patent Application Publication
(10) Pub. No.: US 2025/0164854 A1
(43) Pub. Date: May 22, 2025

(54) LENS DRIVING APPARATUS AND CAMERA MODULE

(71) Applicant: ALPS ALPINE CO., LTD., Tokyo (JP)

(72) Inventors: Yuji KODAMA, Miyagi (JP); Katsutoshi SUZUKI, Tokyo (JP); Ryo ABE, Miyagi (JP); Tomokazu SAKANO, Miyagi (JP)

(21) Appl. No.: 19/032,990

(22) Filed: Jan. 21, 2025

Related U.S. Application Data
(63) Continuation of application No. PCT/JP2023/008479, filed on Mar. 7, 2023.

(30) Foreign Application Priority Data
Jul. 22, 2022 (JP) 2022-117511

(51) Int. Cl. G03B 5/00; G02B 7/02

(52) U.S. Cl. CPC G03B 5/00; G02B 7/026; G03B 2205/0061

(57) ABSTRACT

A lens driving apparatus includes a fixed member, a lens holding member, a piezoelectric driving part having a piezoelectric element extending in a direction perpendicular to an optical axis direction, a receiving member, and a biasing member, the lens holding member moves relative to the fixed member by movement of the piezoelectric element, the biasing member is composed of a leaf spring member, the piezoelectric driving part includes a contact member and a flexible printed circuit, the piezoelectric element and the contact member are fixed with one adhesive, the flexible printed circuit and the supporting part are fixed with another adhesive, and the Young's modulus of the other adhesive is smaller than the Young's modulus of the one adhesive.

This application is a continuation application of International Application no. PCT/JP2023/008479, filed on Mar. 7, 2023, and designated the U.S., which is based upon and claims priority to Japanese Patent Application no. 2022-117511, filed on Jul. 22, 2022, the entire contents of which are incorporated herein by reference.

### BACKGROUND OF THE INVENTION

### 1. Field of the Invention

The disclosure herein relates to, for example, a lens driving apparatus and a camera module mounted on a portable device with a camera.

### 2. Description of the Related Art

Conventionally, a lens driving unit (lens driving apparatus) that can move a lens carrier (lens holding member) in an optical axis direction relative to a module base (base member) by friction drive using bending vibration of a piezoelectric element is known (see Patent Literature (PTL) 1). In this apparatus, a piezoelectric driving part including a piezoelectric element is biased to the lens holding member direction by a plurality of coil springs and pressed against an axial guide part (receiving member) which is fixed to the lens holding member.

However, a structure in which the piezoelectric driving part is biased to the receiving member direction by the plurality of coil springs may be complicated.

Therefore, it is desirable to provide a lens driving apparatus in which a piezoelectric driving part can be biased to a receiving member direction with a simpler structure.

### CITATION LIST

### Patent Literature

[PTL 1] Japanese Laid-Open Patent Publication No. 2010-097216

### SUMMARY OF THE INVENTION

A lens driving apparatus includes a fixed member, a lens holding member capable of holding a lens body, a piezoelectric driving part provided on a first member from among a movable member including the lens holding member and the fixed member, and having a piezoelectric element extending in a direction perpendicular to an optical axis direction, a receiving member which is provided on a second member from among the movable member and the fixed member, and configured to be in contact with the piezoelectric driving part, and a biasing member configured to bias the piezoelectric driving part in a direction of the receiving member, wherein the lens holding member is configured to move relative to the fixed member by movement of the piezoelectric element, wherein the biasing member is composed of a leaf spring member, and includes a fixed part fixed to the first member from among the movable member and the fixed member, a supporting part configured to support the piezoelectric driving part, and an elastic deformation part that is capable of elastically deforming and provided between the fixed part and the supporting part, wherein the piezoelectric driving part includes a contact member fixed to one surface of the piezoelectric element facing the receiving member, and a flexible printed circuit fixed to another surface of the piezoelectric element, wherein the piezoelectric element and the contact member are fixed with one adhesive, wherein the flexible printed circuit and the supporting part are fixed with another adhesive, and wherein a Young's modulus of the another adhesive is smaller than a Young's modulus of the one adhesive.

In the above-described lens driving apparatus, the piezoelectric driving part can be biased to the receiving member direction with a simpler structure.

### BRIEF DESCRIPTION OF THE DRAWINGS

FIG. 1 is an exploded perspective view of a camera module including a lens driving apparatus;

FIG. 2 is an exploded perspective view of the lens driving apparatus shown in FIG. 1;

FIG. 3 is an exploded perspective view of the piezoelectric driving part shown in FIG. 2;

FIG. 4 is a top view of the base member shown in FIG. 2;

FIG. 5 is a right side view of a lens holding member shown in FIG. 2;

FIG. 6 is a perspective view of a biasing member shown in FIG. 2;

FIG. 7 is a rear view of the biasing member shown in FIG. 2;

FIG. 8 is a left side view of the biasing member shown in FIG. 2;

FIG. 9A is a table illustrating characteristics of adhesives used in a piezoelectric driving part shown in FIG. 2;

FIG. 9B is a graph illustrating a relation between a frequency of a bending vibration and a thrust by the piezoelectric driving part of a first example;

FIG. 9C is a graph illustrating a relation between a frequency of a bending vibration and a thrust by the piezoelectric driving part of a second example;

FIG. 10 is a perspective view of another configuration example of the lens driving apparatus;

FIG. 11 is an exploded perspective view of the lens driving apparatus shown in FIG. 10;

FIG. 12 is a top view of a base member shown in FIG. 11;

FIG. 13 is a right side view of a lens holding member shown in FIG. 11;

FIG. 14 is a perspective view of a biasing member shown in FIG. 11;

FIG. 15 is a rear view of the biasing member shown in FIG. 11; and

FIG. 16 is a left side view of the biasing member shown in FIG. 11.

### DESCRIPTION OF THE PREFERRED EMBODIMENTS

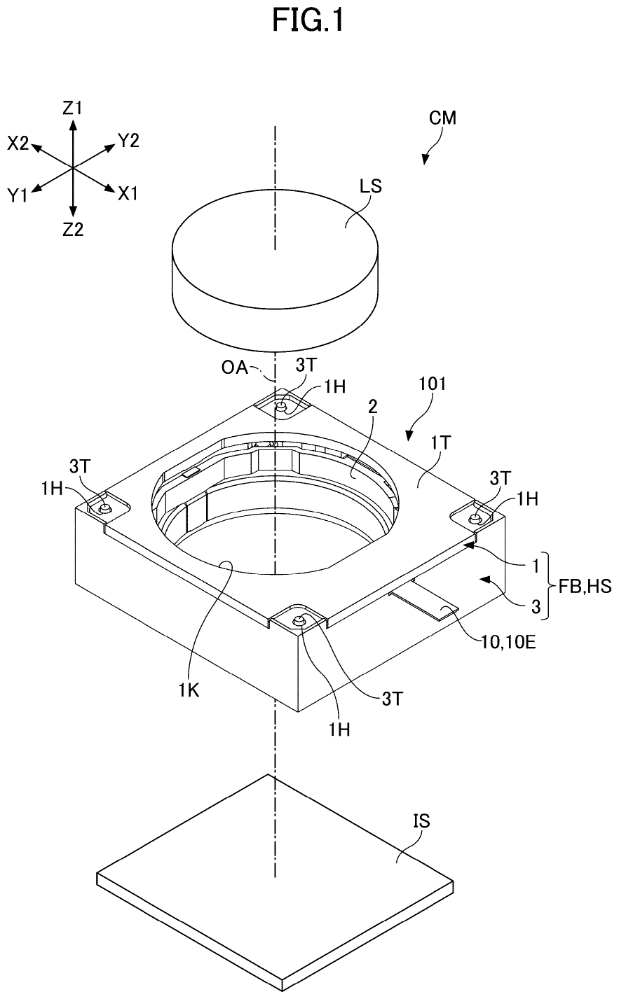

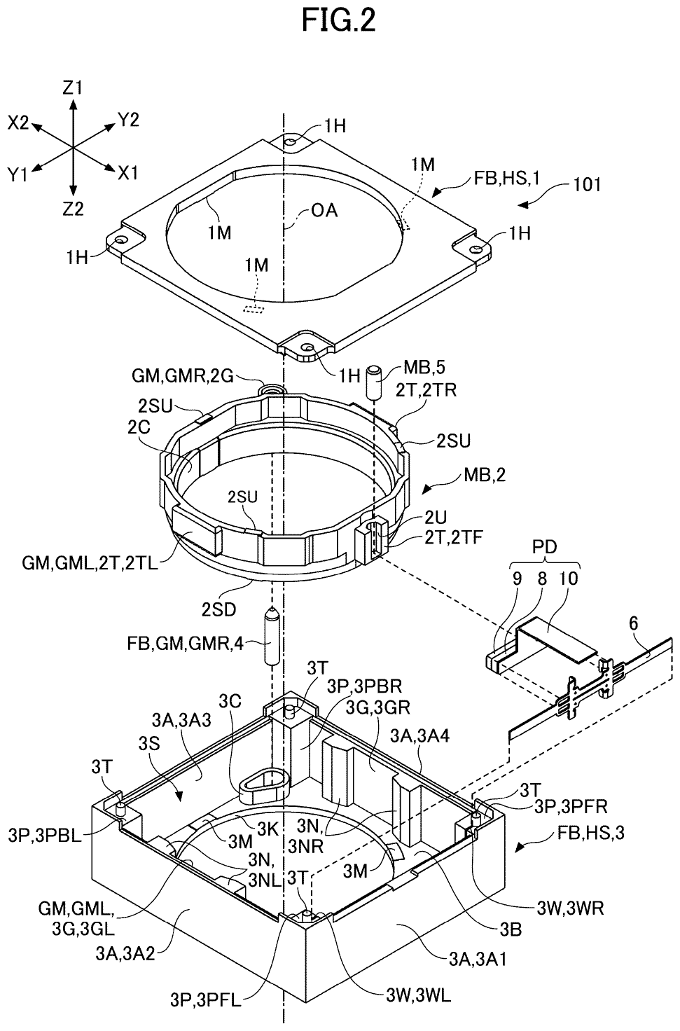

In the following, a lens driving apparatus 101 according to embodiments of the present disclosure will be described with reference to FIG. 1 and FIG. 2. FIG. 1 is an exploded perspective view of a camera module CM including the lens driving apparatus 101. FIG. 2 is an exploded perspective view of the lens driving apparatus 101.

In FIG. 1, X1 represents one of directions along an X-axis in a three-dimensional Cartesian coordinate system, and X2 represents the other direction of the X-axis. Y1 represents one of directions along a Y-axis in a three-dimensional Cartesian coordinate system, and Y2 represents the other direction of the Y-axis. Z1 represents one of the directions along of a Z-axis in a three-dimensional Cartesian coordinate system, and Z2 represents the other direction of the Z-axis. In the present embodiment, the X1 direction of the lens driving apparatus 101 corresponds to a front (front face) of the lens driving apparatus 101, and the X2 direction of the driving lens apparatus 101 corresponds to a rear (rear face) of the lens driving apparatus 101. The Y1 direction of the lens driving apparatus 101 corresponds to the left face of the lens driving apparatus 101, and the Y2 direction of the lens driving apparatus 101 corresponds to the right face of the lens driving apparatus 101. The Z1 direction of the lens driving apparatus 101 corresponds to a top (facing a subject) of the lens driving apparatus 101, and the Z2 direction of the lens driving apparatus 101 corresponds to a bottom (facing an imaging sensor) of the lens driving apparatus 101. The same applies in other figures.

The camera module CM is composed of a lens driving apparatus 101, a lens body LS, and an imaging sensor IS mounted on a substrate (not shown) so as to face the lens body LS. The lens driving apparatus 101 has a substantially rectangular parallelepiped outer shape, and is mounted on a substrate on which the imaging sensor IS is mounted.

In the present embodiment, the lens driving apparatus 101 includes a fixed member FB and a movable member MB, as shown in FIGS. 1 and 2. In the illustrated example, the fixed member FB includes a cover member 1, a base member 3, and a guide shaft 4, and the movable member MB includes a lens holding member 2 and a receiving member 5. The movable member MB is configured to be guided in an optical axis direction by a guide mechanism GM. The optical axis direction includes a direction of an optical axis OA with respect to the lens body LS held by the lens holding member 2 and a direction parallel to the optical axis OA. The lens body LS is, for example, a tubular lens barrel provided with at least one lens. The movable member MB is configured to be moved in the optical axis direction by force generated by the piezoelectric driving part PD.

The cover member 1 is configured to cover the top of the movable member MB. In the present embodiment, the cover member 1 is manufactured by applying punching, drawing, and the like, to a metal plate. However, the cover member 1 may be formed of another material such as a synthetic resin. Specifically, as shown in FIG. 1, the cover member 1 has a flat and rectangular annular top plate 1T. A circular opening 1K is formed in the center of the top plate 1T.

The base member 3 constitutes a part of a housing HS. In the present embodiment, the base member 3 is formed of a synthetic resin. However, the base member 3 may be formed of a metal. The cover member 1 is joined to the base member 3 with an adhesive or the like to constitute the housing HS together with the base member 3.

As shown in FIG. 2, the lens holding member 2 is configured to be able to hold the lens body LS in the tubular part 2C with an adhesive. In the example shown in FIG. 2, the lens holding member 2 is manufactured by injection molding a synthetic resin such as liquid crystal polymer (LCP). The lens holding member 2 has a protrusion 2T and a guide part 2G protruding radially (outward) from an outer peripheral surface of the tubular part 2C that has a tubular shape. The protrusion 2T includes a front protrusion 2TF protruding forward from the outer peripheral surface of the tubular part 2C, a left protrusion 2TL protruding leftward from the outer peripheral surface of the tubular part 2C, and a right protrusion 2TR protruding rightward from the outer peripheral surface of the tubular part 2C. The guide part 2G has a through hole for receiving the guide shaft 4.

The receiving member 5 is a member receiving a driving force generated by the piezoelectric driving part PD. In the present embodiment, the receiving member 5 is a tubular member formed of a metal such as titanium copper or stainless steel and extending in the optical axis direction. The receiving member 5 may be formed of another metal, and the other metal may be either a magnetic metal or a non-magnetic metal. In the example shown in FIG. 2, the receiving member 5 is fitted and fixed in a U-shaped groove 2U formed in the front protrusion 2TF of the lens holding member 2, and is configured to move in the optical axis direction together with the lens holding member 2.

The biasing member 6 is configured to bias the piezoelectric driving part PD toward the receiving member 5. In the example shown in FIG. 2, the biasing member 6 is formed of a leaf spring member formed by applying press work to a metal plate made of titanium copper using a forward feed type. The metal plate may be formed of other metal such as stainless steel. In the example shown in FIG. 2, both ends of the biasing member 6 are fixed to an inner peripheral surface of the base member 3, and the piezoelectric driving part PD can be pressed toward the receiving member 5 fixed to the lens holding member 2.

The piezoelectric driving part PD is configured to be able to move the lens holding member 2 along the optical axis direction. In the present embodiment, the piezoelectric driving part PD is an example of a friction drive part using the driving system disclosed in U.S. Pat. No. 7,786,648, and includes a piezoelectric element 8, a contact member 9, and a flexible printed circuit 10. The piezoelectric driving part PD is biased inward (toward the optical axis OA) by the biasing member 6 and is pressed against the receiving member 5.

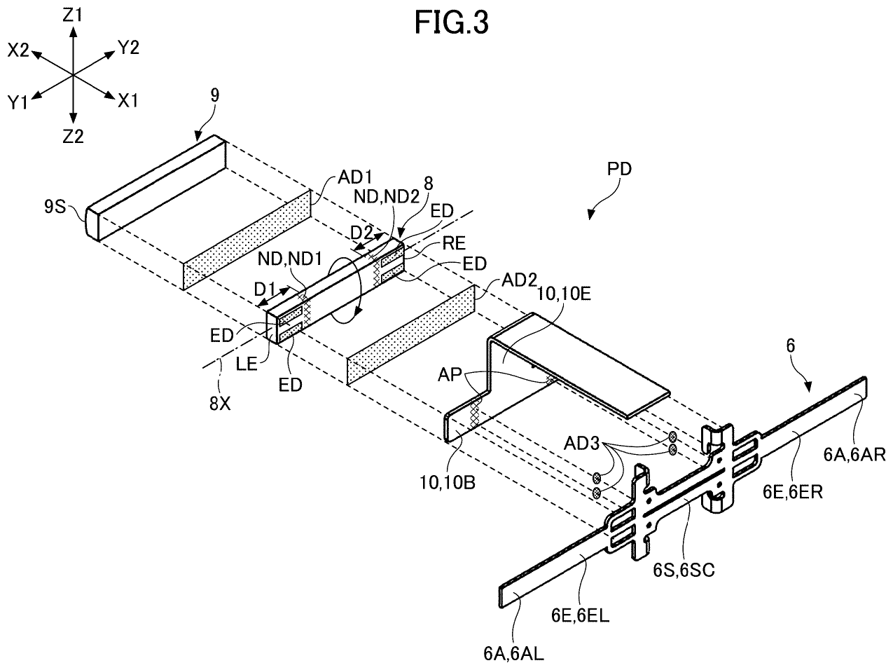

The piezoelectric element 8 is configured to achieve bending vibration according to an applied voltage. In the present embodiment, as shown in FIG. 3, the piezoelectric element 8 extends in the Y-axis direction perpendicular to the optical axis direction (perpendicular to the optical axis OA), and is configured to achieve bending vibration having two nodes (ND). That is, when bending vibration is performed, portions of the two nodes ND hardly vibrate.

FIG. 3 is an exploded perspective view of the piezoelectric driving part PD supported by the biasing member 6. In FIG. 3, positions of the nodes ND in the piezoelectric element 8 and the positions AP corresponding to the nodes ND in the flexible printed circuit 10 are provided with a cross pattern for clarity. The positions of the nodes ND in the piezoelectric element 8 include the positions of the first node ND1 and the second node ND2. The positions of the nodes ND correspond to positions at a predetermined distance from an end of the piezoelectric element 8 in the Y-axis direction. The predetermined distance is, for example, approximately a quarter of a total length of the piezoelectric element 8. Specifically, the position of the first node ND1 is at a distance D1 from the left end LE of the piezoelectric element 8, and the position of the second node ND2 is at a distance D2 from the right end RE of the piezoelectric element 8. Both distances D1 and D2 are approximately a quarter of the total length of the piezoelectric element 8.

In the example shown in FIG. 3, the piezoelectric element 8 has a two-layer structure laminated in the X-axis direction consisting of a first layer that achieves the first bending vibration on a virtual plane parallel to the XY plane and a second layer that achieves the second bending vibration on a virtual plane parallel to the YZ plane. When voltage is applied to the piezoelectric element portion constituting the first layer and voltage is applied to the piezoelectric element portion constituting the second layer separately at appropriate timing, the piezoelectric driving part PD can cause the piezoelectric element 8 to bend and vibrate (circularly move) so that a locus drawn by a midpoint of the piezoelectric element 8 becomes a circular orbit around the rotation axis 8X when viewed from the left direction. That is, the piezoelectric element 8 can achieve the motion in which the midpoint of the piezoelectric element 8 draws a circle (circularly move). In the example shown in FIG. 3, the rotation axis 8X is parallel to the Y-axis. When voltage is applied at appropriate timing, the piezoelectric driving part PD can switch the moving direction (rotational direction) of the midpoint following the circular orbit between a clockwise direction and a counterclockwise direction when viewed from the Y1 direction. By switching the rotational direction, the piezoelectric driving part PD can switch the moving direction of the lens holding member 2 along the optical axis direction. The circle (circular orbit) drawn by the midpoint of the piezoelectric element 8 is not required to be a perfect circle, and may be approximately circular.

In FIG. 3, an arrow drawn around the piezoelectric element 8 indicates bending vibration (Circular motion in which the piezoelectric element 8 rotates clockwise as viewed from the Y1 direction around the rotation axis 8X while flexing) of the piezoelectric element 8. In this case, the movable member MB including the receiving member 5 in contact with the contact member 9 of the piezoelectric driving part PD moves upward (Z1 direction). Although not indicated by an arrow, the piezoelectric element 8 can also rotate counterclockwise when viewed from the Y1 direction around the rotation axis 8X while flexing. In this case, the movable member MB including the receiving member 5 in contact with the contact member 9 of the piezoelectric driving part PD moves downward (Z2 direction).

That is, the lens holding member 2 to which the receiving member 5 is attached is moved upward (Z1 direction) when the rotation direction of the middle point of the piezoelectric element 8 is clockwise in the left side view, and is moved downward (Z2 direction) when the rotation direction of the middle point of the piezoelectric element 8 is counterclockwise. In the example shown in FIG. 3, the middle point of the piezoelectric element 8 is a point corresponding to the top of the amplitude of the first bending vibration (a point corresponding to the antinode of the first bending vibration) and a point corresponding to the top of the amplitude of the second bending vibration (a point corresponding to the antinode of the second bending vibration).

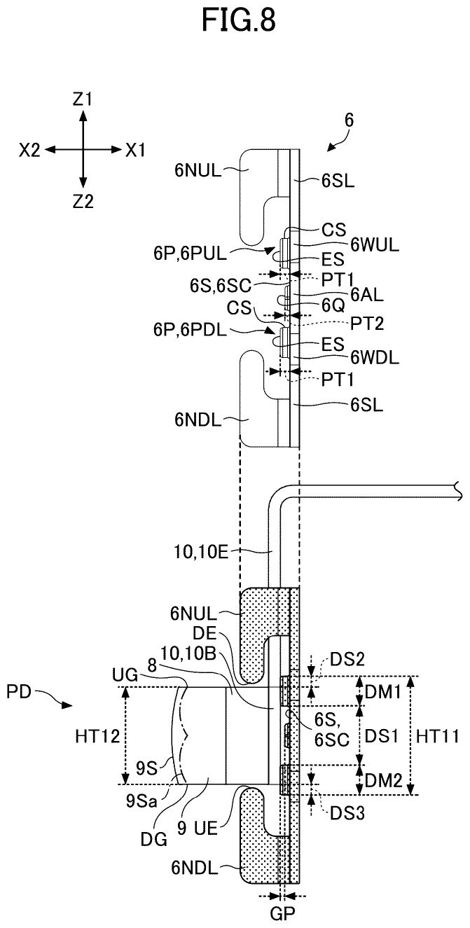

The contact member 9 is attached to the piezoelectric element 8 and is configured to contact the receiving member 5. In the present embodiment, the contact member 9 is bonded to the inner surface of the piezoelectric element 8 with the first adhesive AD1 so as to cover the entire inner surface of the piezoelectric element 8 (X2 direction facing the optical axis OA). The contact member 9 is formed of a metal such as titanium copper or stainless steel, and has an appropriate thickness so that bending vibration (circular motion) can be performed in response to bending vibration (circular motion) of the piezoelectric element 8. In the example shown in FIG. 3, the contact member 9 is a friction plate formed of stainless steel. The contact member 9 extends in the same Y-axis direction as the extension direction of the piezoelectric element 8. Moreover, the contact member 9 is configured to be in contact with the receiving member 5 at the center in the extension direction. Specifically, the contact member 9 is configured to be in contact with the receiving member 5 at the portion where the amplitude of the bending vibration (circular motion) is maximum (the portion corresponding to the antinode of the bending vibration). In the example shown in FIG. 3, the contact member 9 has a convex curved surface in which the surface 9S in contact with the receiving member 5 (X2 direction) is convex to the X2 direction. That is, the surface 9S is configured to form a surface having one convex part. However, the surface 9S may be configured to be a surface having two or more convex parts (for example, refer to the surface 9Sa shown by a long dashed short dashed line in the figure below of FIG. 8).

The reason why the metal receiving member 5 and the metal contact member 9 are brought into contact with each other is to prevent wear of the lens holding member 2 due to contact between the synthetic resin lens holding member 2 and the metal contact member 9. If the receiving member 5 and the contact member 9 can be brought into contact with each other, the length of the contact member 9 in the Y-axis direction need not be the same as the length of the piezoelectric element 8 in the Y-axis direction. For example, the length of the contact member 9 in the Y-axis direction may be smaller than the length of the piezoelectric element 8 in the Y-axis direction.

The flexible printed circuit 10 includes a conductive pattern (not shown), and is configured to electrically connect the piezoelectric element 8 to an external voltage supply source (control circuit). In the present embodiment, the flexible printed circuit 10 is configured to apply a voltage to the piezoelectric element 8. Specifically, the flexible printed circuit 10 includes a joint part 10B to be joined to the piezoelectric element 8, and an extension 10E extending outward from the joint part 10B.

As shown in FIG. 3, the piezoelectric element 8 is joined to the inner surface (X2 direction facing the optical axis OA) of the flexible printed circuit 10 with a second adhesive AD2. In the illustrated example, the second adhesive AD2 is an anisotropic conductive film. However, the second adhesive AD2 may be an isotropic conductive film, an anisotropic conductive adhesive, isotropic conductive adhesive. In the illustrated example, the piezoelectric element 8 has electrodes ED at each of the four corners of the outer surface (X1 direction). The electrodes ED of the piezoelectric element 8 are bonded to conductive parts (conductive patterns) formed on the inner surface of the flexible printed circuit 10 with the second adhesive AD2.

The piezoelectric driving part PD is biased inward (toward the optical axis OA) by the biasing member 6 fixed to the base member 3, and is pressed against the receiving member 5. In the example shown in FIG. 3, the biasing member 6 is configured to be in contact with the outer surface of the flexible printed circuit 10 (X1 direction, which is far from the optical axis OA) at the position AP corresponding to each of the two nodes ND formed during the bending vibration of the piezoelectric element 8. Joining of the biasing member 6 and the flexible printed circuit 10 is achieved by, for example, a third adhesive AD3.

As shown in FIG. 2, the base member 3 has a substantially rectangular tubular outer peripheral wall 3A defining the housing part 3S, and a flat plate and rectangular annular bottom plate 3B. Specifically, the outer peripheral wall 3A includes first lateral plates 3A1 to fourth lateral plates 3A4. The first lateral plate 3A1 and third lateral plate 3A3 face each other, and the second lateral plate 3A2 and fourth lateral plate 3A4 face each other. The second lateral plate 3A2 and the fourth lateral plate 3A4 extend perpendicularly to the first lateral plate 3A1 and the third lateral plate 3A3. That is, the first lateral plate 3A1 and the third lateral plate 3A3 extend perpendicularly to the second lateral plate 3A2 and the fourth lateral plate 3A4.

A pair of regulating parts for 3N regulating the movement of the lens holding member 2 is formed on the inner surfaces of the second lateral plate 3A2 and the fourth lateral plate 3A4. A groove part 3G for receiving the protrusion 2T of the lens holding member 2 is formed between the regulating parts 3N. Specifically, a pair of left regulating parts 3NL are formed on the inner surfaces of the second lateral plate 3A2, and a pair of right regulating parts 3NR are formed on the inner surfaces of the fourth lateral plate 3A4. A left groove part 3GL for receiving the left protrusion 2TL of the lens holding member 2 is formed between the pair of left regulating parts 3NL, and a right groove part 3GR for receiving the right protrusion 2TR of the lens holding member 2 is formed between the pair of right regulating parts 3NR.

Columnar parts 3P protruding upward are formed at each of the four corners of the bottom plate 3B. A tubular adhesive reservoir 3C protruding upward is provided on the upper surface of the bottom plate 3B, and a circular opening 3K is formed in the central portion of the bottom plate 3B.

Specifically, the columnar parts 3P include a left rear columnar part 3PBL, a right rear columnar part 3PBR, a left front columnar part 3PFL, and a right front part columnar 3PFR. Cylindrical connecting pins 3T protruding upward are formed on the upper surfaces of the left rear columnar part 3PBL, the right rear columnar part 3PBR, the left front columnar part 3PFL, and the right front columnar part 3PFR. The four connecting pins 3T are formed so as to be fitted into four circular through holes 1H formed at the four corners of the cover member 1. In the illustrated example, bonding between the cover member 1 and the base member 3 is achieved by applying adhesive to the through holes 1H and the connecting pins 3T while the connecting pins 3T are fitted into the through holes 1H as shown in FIG. 1.

Clamping parts 3W are formed in the left front columnar part 3PFL and the right front columnar part 3PFR. The clamping parts 3W are slit-shaped grooves configured to be able to clamp the biasing member 6, and include the left clamping parts 3WL and the right clamping parts 3WR. In the example shown in FIG. 2, the left clamping parts 3WL are formed on the right surface of the left front columnar part 3PFL, and the right clamping parts 3WR are formed on the left surface of the right front columnar part 3PFR.

The guide mechanism GM is configured to guide the lens holding member 2 movably in the optical axis direction with respect to the fixed member FB. In the present embodiment, the guide mechanism GM includes a combination of a guide part 2G formed on the outer peripheral surface of the tubular part 2C of the lens holding member 2 and a guide shaft 4. The combination of the left protrusion 2TL formed in the tubular part 2C of the lens holding member 2 and the left groove part 3GL formed in the second lateral plate 3A2 of the base member 3, or the combination of the right protrusion 2TR formed in the tubular part 2C of the lens holding member 2 and the right groove part 3GR formed in the fourth lateral plate 3A4 of the base member 3 may function as a part of the guide mechanism GM. Alternatively, the combination of the left protrusion 2TL and the left groove part 3GL, and the combination of the right protrusion 2TR and the right groove part 3GR may function as the guide mechanism GM. In this case, the combination of the guide part 2G and the guide shaft 4 may be omitted. This is because when each of the three combinations functions as the guide mechanism GM, the lens holding member 2 may not be smoothly guided if the dimensional accuracy of the components is poor. However, each of the three combinations may function as the guide mechanism GM.

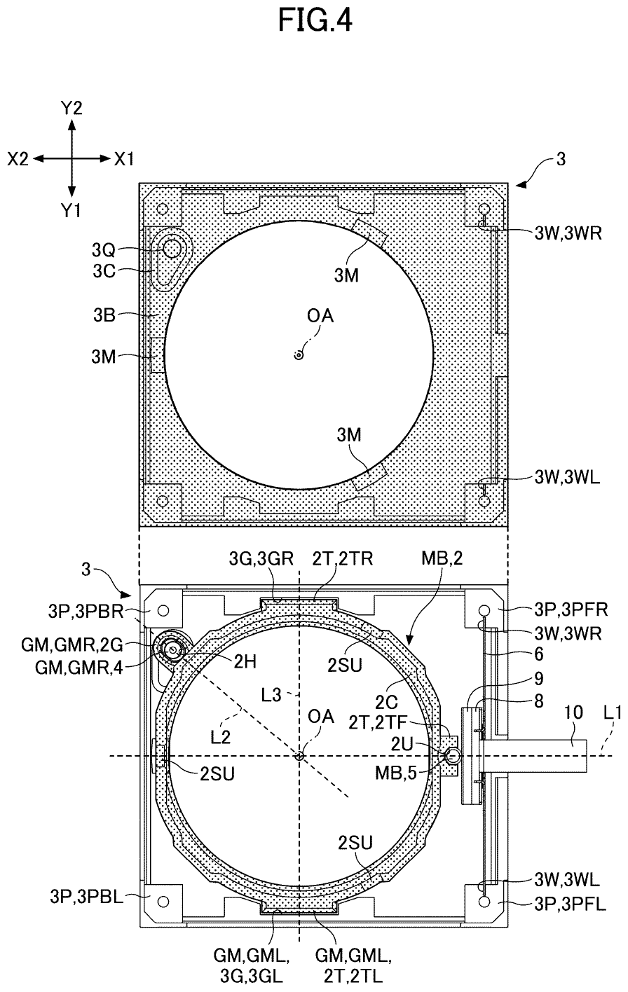

In the illustrated example, the guide mechanism GM includes two guide mechanisms (left guide mechanism GML and right guide mechanism GMR) arranged so as to face the lens holding member 2 in both directions (Y1 direction and Y2 direction) of the line segment L1 passing through the optical axis OA and the center of the receiving member 5, as shown in the lower figure of FIG. 4. FIG. 4 is a top view of the base member 3. Specifically, the upper view of FIG. 4 is a top view of the base member 3 in a state where the lens holding member 2, the guide shaft 4, the receiving member 5, the biasing member 6, and the piezoelectric driving part PD are not attached, and the lower view of FIG. 4 is a top view of the base member 3 in a state where the lens holding member 2, the guide shaft 4, the receiving member 5, the biasing member 6, and the piezoelectric driving part PD are attached. For clarity, in the upper figure of FIG. 4, a dot pattern is applied to the base member 3, and in the lower figure of FIG. 4, a dot pattern is applied to the lens holding member 2.

As shown in the upper figure of FIG. 4, the guide shaft 4 is fixed to the base member 3 with adhesive applied inside the tubular adhesive reservoir 3C formed in the bottom plate 3B of the base member 3. Specifically, the guide shaft is fixed to the base member 3 with the adhesive in a state where the lower end of the guide shaft 4 is fitted into the circular recess 30 formed in the inner bottom surface of the adhesive reservoir 3C. In addition, as shown in the lower figure of FIG. 4, the guide shaft 4 is inserted into the square rectangular through hole 2H formed in the guide part 2G of the lens holding member 2 in the top view. The square rectangular shape has two sides of equal length and two semicircles, and the radius of the semicircles is approximately the same as the radius of the guide shaft 4. The sides of the square rectangular shape are parallel to the line segment L2 passing through the optical axis OA and the center of the guide shaft 4.

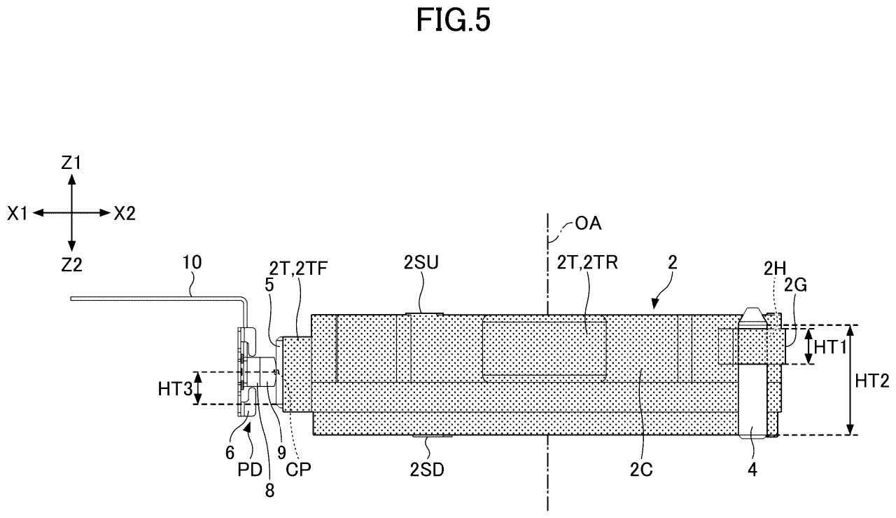

In the illustrated example, as shown in FIG. 5, the guide part 2G is configured so that the length HT1 in the optical axis direction is smaller than the length HT2 of the tubular part of the guide shaft 4.

FIG. 5 is a right side view of the lens holding member 2, the guide shaft 4, the receiving member 5, the biasing member 6, and the piezoelectric driving part PD. Specifically, FIG. 5 shows the positional relation between the lens holding member 2 and the guide shaft 4, the receiving member 5, the biasing member 6, and the piezoelectric driving part PD when the lens holding member 2 is at its lowest position. In FIG. 5, a dot pattern is applied to the lens holding member 2 for clarity.

In the lens holding member 2, when the lens holding member 2 is at its lowest position, the three lower stopper parts 2SD provided at the lower end of the tubular part 2C are configured to be in contact with the three protrusions 3M (see FIG. 2) provided so as to project upward from the upper surface of the bottom plate 3B of the base member 3. In the lens holding member 2, when the lens holding member 2 is at its highest position, the three upper stopper parts 2SU provided at the upper end of the tubular part 2C are configured to be in contact with the three protrusions 1M (see FIG. 2) provided so as to protrude downward from the lower surface of the top plate 1T of the cover member 1.

In the illustrated example, the guide part 2G is configured so that the length HT1 in the optical axis direction is larger than the length dimension HT3, as shown in FIG. 5. The length dimension HT3 is the distance between the contact point CP between the receiving member 5 and the contact member 9 and the lower end of the tubular part of the receiving member 5 when the lens holding member 2 is at its lowest position.

With this configuration, even when the lens holding member 2 reaches its highest position, the guide part 2G can keep at least a part of the tubular part of the guide shaft 4 in the through hole 2H, and therefore, the movement of the lens holding member 2 can be stabilized over the entire range of the movement range of the lens holding member 2 in the optical axis direction.

As shown in the lower drawing of FIG. 4, the receiving member 5 and at least one of the guide mechanism GM (right guide mechanism GMR) are arranged so as to face each other in both directions (X1 direction and X2 direction) of the line segment L3 perpendicular to the line segment L1 and passing through the optical axis OA, sandwiching the lens holding member 2. With such an arrangement, the guide mechanism GM can stably move the lens holding member 2 along the optical axis direction.

In the lens driving apparatus 101 described above, the piezoelectric element 8 is connected to an external voltage supply source (control circuit) via the flexible printed circuit 10. When a voltage is applied to the piezoelectric element 8, the piezoelectric element 8 performs first bending vibration and second bending vibration to generate a force to move the lens holding member 2 along the optical axis direction. This force is a frictional force due to contact between the receiving member 5 attached to the lens holding member 2 and the contact member 9 bonded to the piezoelectric element 8.

The lens driving apparatus 101 uses this force to achieve an automatic focusing function by moving the lens holding member 2 along the optical axis direction in the Z1 direction (facing the subject) of the imaging sensor IS. Specifically, the lens driving apparatus 101 moves the lens holding member 2 in a direction away from the imaging sensor IS to enable macro photography, and moves the lens holding member 2 in a direction approaching the imaging sensor IS to enable infinity photography.

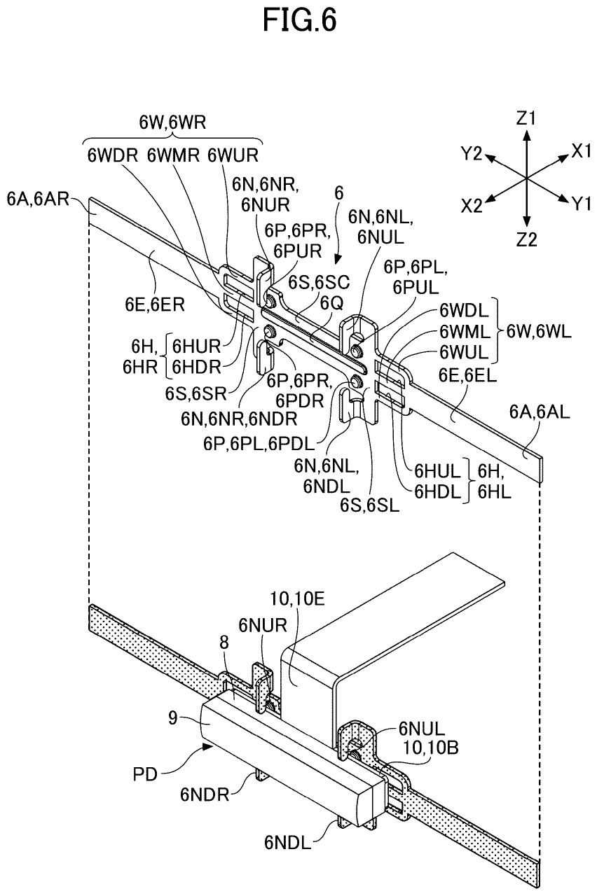

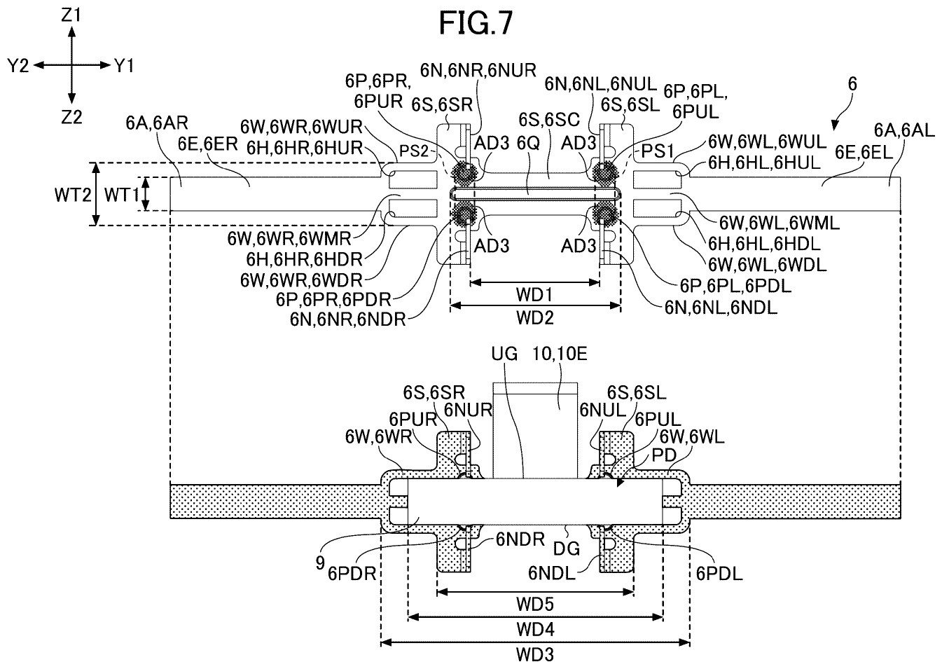

Next, details of the biasing member 6 will be described with reference to FIGS. 6 to 8. FIG. 6 is a perspective view of the biasing member 6. Specifically, the upper view of FIG. 6 is a perspective view of the biasing member 6 with the piezoelectric driving part PD removed. The lower view of FIG. 6 is a perspective view of the biasing member 6 with the piezoelectric driving part PD attached. FIG. 7 is a rear view of the biasing member 6. Specifically, the upper view of FIG. 7 is a rear view of the biasing member 6 with the piezoelectric driving part PD removed. The lower view of FIG. 7 is a rear view of the biasing member 6 with the piezoelectric driving part PD attached. FIG. 8 is a left side view of the biasing member 6. Specifically, the upper view of FIG. 8 is a left side view of the biasing member 6 with the piezoelectric driving part PD removed. The lower figure in FIG. 8 is a left side view of the biasing member 6 in a state where the piezoelectric driving part PD is attached. In the lower figures in FIGS. 6 to 8, the biasing member 6 has a dot pattern for clarity.

In the present embodiment, the biasing member 6 is composed of a leaf spring member formed from a single metal plate. Specifically, as shown in the upper figures in FIGS. 6 to 8, the biasing member 6 has a fixed part 6A fixed to the base member 3, a supporting part 6S supporting the piezoelectric driving part PD, an elastic deformation part 6E, which is elastically deformable, provided between the fixed part 6A and the supporting part 6S, and bent parts 6N bent in an L-shape from the supporting part 6S and protruding toward the direction where the lens holding member 2 is located (X2 direction). The fixed part 6A is a portion clamped by the clamping part 3W of the base member 3. Fixing of the fixed part 6A to the base member 3 may be reinforced with an adhesive in addition to being clamped by the clamping part 3W.

Specifically, the fixed part 6A includes a left fixed part 6AL and a right fixed part 6AR, and the supporting part 6S includes a base part 6SC, a left supporting part 6SL, and a right supporting part 6SR. The elastic deformation part 6E includes a left elastic deformation part 6EL provided between the left fixed part 6AL and the left supporting part 6SL, and a right elastic deformation part 6ER provided between the right fixed part 6AR and the right supporting part 6SR. The bent parts 6N include left bent parts 6NL extending backward (in the X2 direction) from the left supporting part 6SL and right bent parts 6NR extending backward (in the X2 direction) from the right supporting part 6SR. The left bent parts 6NL include an upper left bent part 6NUL extending backward (in the X2 direction) from the upper end of the left supporting part 6SL and a lower left bent part 6NDL extending backward (in the X2 direction) from the lower end of the left supporting part 6SL. The right bent parts 6NR include an upper right bent part 6NUR extending backward (in the X2 direction) from the upper end of the right supporting part 6SR and a lower right bent part 6NDR extending backward (in the X2 direction) from the lower end of the right supporting part 6SR.

The base part 6SC includes four projections 6P protruding backward (in the X2 direction) and having circular end faces, and one protrusion 6Q protruding backward (in the X2 direction) and having rounded rectangular end faces. In the illustrated example, the protrusion 6Q is a draw bead formed by drawing. The protrusion 6Q may be omitted. In the illustrated example, both of the four projections 6P and one protrusion 6Q are formed by drawing, doweling, or semi-punching, not by bending, and are formed so that the end faces are flat. Therefore, as shown in FIG. 3, recesses corresponding to each of the four projections 6P and one protrusion 6Q are formed in the front surface (X1 direction surface) of the base part 6SC. The protrusion 6Q may be formed so as to protrude forward (X1 direction). In this case, the recess corresponding to the protrusion 6Q is formed on the rear surface (X2 direction surface) of the base part 6SC.

The end surface of the projection 6P has a circular shape, but may have other shapes such as an elliptical shape or a rounded rectangle. The same applies to the end surface of the protrusion 6Q. Specifically, as shown in the upper drawing of FIG. 7, the protrusion 6Q extends along the extending direction (Y-axis direction) of the piezoelectric element 8 and is formed so as to have a width WD2 larger than the width WD1, which is the distance between the left bent part 6NL and the right bent part 6NR. The projections 6P include an upper left projection 6PUL disposed above the left end of the protrusion 6Q, a lower left projection 6PDL disposed below the left end of the protrusion 6Q, an upper right projection 6PUR disposed above the right end of the protrusion 6Q, and a lower right projection 6PDR disposed below the right end of the protrusion 6Q. Hereinafter, the upper left projection 6PUL and the lower left projection 6PDL may be referred to as the left projection 6PL, and the upper right projection 6PUR and the lower right projection 6PDR may be referred to as the right projection 6PR. The position where the projection 6P is disposed is preferably a position corresponding to the node ND of the piezoelectric element 8, and specifically includes the first position PS1 and the second position PS2 which are disposed apart from each other in the extending direction (Y-axis of direction) the piezoelectric element 8. The upper left projection 6PUL and the lower left projection 6PDL are disposed at the first position PS1, and the upper right projection 6PUR and the lower right projection 6PDR are disposed at the second position PS2.

The elastic deformation part 6E may have a wide part 6W for preventing the torsion of the biasing member 6 caused by bending vibration of the piezoelectric element 8. In the illustrated example, the wide part 6W is formed to have a longitudinal width WT2 larger than the longitudinal width WT1 of the other portions of the elastic deformation part 6E, as shown in the upper view of FIG. 7. The wide part 6W includes a left wide part 6WL extending leftward (Y1 direction) from the left supporting part 6SL and a right wide part 6WR extending rightward from the right supporting part 6SR. Further, a through hole 6H is formed in the wide part 6W. Specifically, a left through hole 6HL is formed in the left wide part 6WL, and a right through hole 6HR is formed in the right wide part 6WR. More specifically, the left through hole 6HL includes an upper left through hole 6HUL and a lower left through hole 6HDL, and the right through hole 6HR includes an upper right through hole 6HUR and a lower right through hole 6HDR. Therefore, the left wide part 6WL is divided into three connecting parts (upper left connecting part 6WUL, center left connecting part 6WML, and lower left connecting part 6WDL), and the right wide part 6WR is divided into three connecting parts (upper right connecting part 6WUR, center right connecting part 6WMR, and lower right connecting part 6WDR).

In the illustrated example, the wide part 6W is formed so that the width WD3, which is the distance between the left end of the left wide part 6WL and the right end of the right wide part 6WR, is larger than the width WD4 of the piezoelectric driving part PD (piezoelectric element 8), as shown in the lower figure of FIG. 7. In the illustrated example, the supporting part 6S is formed so that the width WD5, which is the distance between the left end of the left supporting part 6SL and the right end of the right supporting part 6SR, is smaller than the width WD4 of the driving piezoelectric part PD (piezoelectric element 8), as shown in the lower figure of FIG. 7.

As shown in the lower drawings of FIGS. 6 to 8, the piezoelectric driving part PD is arranged so that the left portion is positioned between the upper left bent part 6NUL and the lower left bent part 6NDL, and the right portion is positioned between the upper right bent part 6NUR and the lower right bent part 6NDR. Specifically, as shown in the lower figures of FIG. 8, the piezoelectric driving part PD is arranged so that the lower end piece DE of the upper left bent part 6NUL and an upper edge UG (upper surface of the piezoelectric element 8) of the piezoelectric driving part PD face each other without making contact, and an upper end piece UE of the lower left bent part 6NDL and the lower edge DG (lower surface of the piezoelectric element 8) of the piezoelectric driving part PD face each other without making contact. The same applies to the relation between the lower end of the upper right bent part 6NUR and an upper edge UG (upper surface of the piezoelectric element 8) of the piezoelectric driving part PD, and the relation between the upper end of the lower right bent part 6NDR and the lower edge DG (lower surface of the piezoelectric element 8) of the piezoelectric driving part PD. In this way, the bent part 6N and the piezoelectric element 8 are combined so that they face each other without making contact.

Further, as shown in the lower figures of FIG. 8, the piezoelectric driving part PD is attached to the biasing member 6 so that the front surface (X1 direction surface) of the joint part 10B of the flexible printed circuit 10 is adhered and fixed to the respective end surfaces of the upper left projection 6PUL and the lower left projection 6PDL with the third adhesive AD3 (see the upper figures of FIG. 7). Additionally, as shown in the lower figures of FIG. 8, the piezoelectric driving part PD is attached to the biasing member 6 so that the front surface (X1 direction surface) of the joint part 10B of the flexible printed circuit 10 and the protrusion 6Q are not in contact with each other, that is, a gap GP is formed between the front surface (X1 direction surface) of the joint part 10B of the flexible printed circuit 10 and the end surface of the protrusion 6Q. Specifically, as shown in the upper drawing of FIG. 8, the projection 6P is formed so as to protrude backward from the rear surface of the supporting part 6S by the protrusion height PT1, and the protrusion 6Q is formed so as to protrude backward from the rear surface of the supporting part 6S by the protrusion height PT2 (<protrusion height PT1). Since the projection 6P is formed by drawing, the protrusion height PT1 can be smaller than that in the case where the projection 6P is formed by folding.

The third adhesive AD3 is an adhesive for bonding and fixing the joint part 10B of the flexible printed circuit 10 and the supporting part 6S of the biasing member 6. Specifically, the third adhesive AD3 is applied to each of the four projections 6P as shown in the upper diagram of FIG. 7 in order to bond and fix the position AP (see FIG. 3) corresponding to the node ND of the piezoelectric element 8 and the four projections 6P at the base part 6SC of the supporting part 6S in the joint part 10B. In the illustrated example, the third adhesive AD3 is applied so as to cover the entire end surface and the entire peripheral surface of each of the four projections 6P and not to adhere to the protrusion 6Q.

In the present the embodiment, third adhesive AD3 is an ultraviolet curable adhesive. However, the third adhesive AD3 may be another type of adhesive such as a moisture curable adhesive or a heat curable adhesive.

As shown in the lower drawing of FIG. 8, the left projection 6PL is formed so that the height dimension HT11 in the optical axis direction is larger than the height dimension HT12 of the piezoelectric driving part PD in the optical axis direction. In the illustrated example, the height dimension HT11 is the distance between the upper end of the upper left projection 6PUL having a diameter DM1 and the lower end of the lower left projection 6PDL having a diameter DM2. The upper left projection 6PUL and the lower left projection 6PDL are arranged with a distance DS1 in the optical axis direction, and the diameters DM1 and DM2 are the same size. That is, the left projection 6PL is formed so as to protrude upward from the upper edge UG of the piezoelectric driving part PD by a distance DS2 and downward from the lower edge DG of the piezoelectric driving part PD by a distance DS3 in the optical axis direction.

In the above-described embodiment, the left projection 6PL is composed of a combination of the upper left projection 6PUL and the lower left projection 6PDL, but it may be composed of one in the Z-axis elongated convex part extending direction. Even in this case, the left projection 6PL is formed so that the height dimension HT11, which is the distance between the upper end and the lower end in the optical axis direction, is larger than the height dimension HT12 of the piezoelectric driving part PD in the optical axis direction. The same applies to the right projection 6PR.

Thus, since the projection 6P is formed so as to protrude outward from both ends of the piezoelectric driving part PD in the optical axis direction, both ends of the joint part 10B of the flexible printed circuit 10 in the optical axis direction can be reliably supported. Therefore, while the projection 6P supports the joint part 10B at the position AP (see FIG. 3) corresponding to the node ND of the piezoelectric element 8, the joint part 10B can be prevented from separating from the end face of the projection 6P due to the bending vibration of the piezoelectric element 8, and the joint part 10B can be prevented from tilting with respect to the end face of the projection 6P.

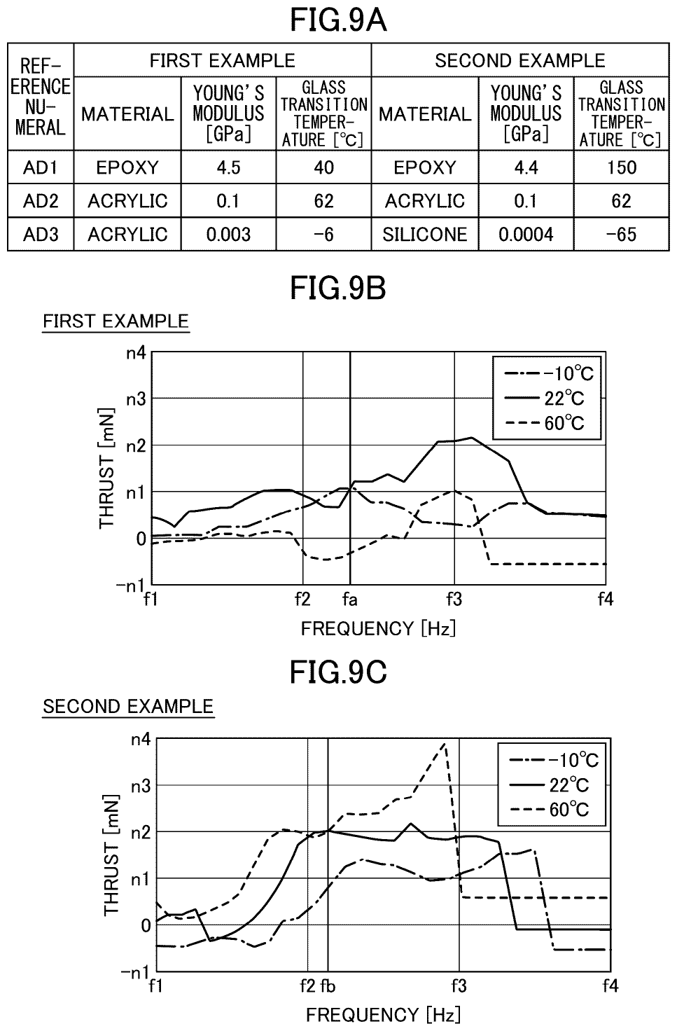

Next, with reference to FIGS. 9A to 9C, the relation between the frequency of bending vibration by the piezoelectric driving part PD and the thrust will be described. FIGS. 9A to 9C is a drawing illustrating a relation between a frequency of a bending vibration and a thrust by the piezoelectric driving part PD. The thrust by the piezoelectric driving part PD is a force to move the lens holding member 2 along the optical axis direction caused by the piezoelectric driving part PD. Specifically, FIG. 9A is a table illustrating characteristics of adhesives used in the piezoelectric driving part PD according to a first example and a second example of the lens driving apparatus 101, respectively. FIG. 9B is a graph illustrating a relation between a frequency of a bending vibration and a thrust by the piezoelectric driving part PD of the first example. FIG. 9C is a graph illustrating a relation between a frequency of a bending vibration and a thrust by the piezoelectric driving part PD of the second example.

The first and second examples differ in that the characteristics of the first adhesive AD1 and third adhesive AD3 are different, wherein the first adhesive AD1 joins the piezoelectric element 8 and the contact member 9, the second adhesive AD2 joins the piezoelectric element 8 and the flexible printed circuit 10, and the third adhesive AD3 joins the flexible printed circuit 10 and the biasing member 6. According to the drawings, in the first and second examples, the first adhesive AD1 is an epoxy adhesive and the second adhesive AD2 is an acrylic adhesive. The third adhesive AD3 is an acrylic adhesive in the first example and a silicone adhesive in the second example.

Specifically, as shown in FIG. 9A, the glass transition temperature (40° C.) of the first adhesive AD1 in the first example is lower than the glass transition temperature (150° C.) of the first adhesive AD1 in the second example, and the Young's modulus (4.5 GPa) of the first adhesive AD1 in the first example is larger than the Young's modulus (4.4 GPa) of the first adhesive AD1 in the second example. The glass transition temperature (−6° C.) of the third adhesive AD3 in the first example is higher than the glass transition temperature (−65° C.) of the third adhesive AD3 in the second example, and a Young's modulus (0.003 GPa) of the third adhesive AD3 in the first example is larger than the Young's modulus (0.0004 GPa) of the third adhesive AD3 in the second example. The glass transition temperature (62° C.) of the second adhesive AD2 in the first example is the same as the glass transition temperature (62° C.) of the second adhesive AD2 in the second example, and the Young's modulus (0.1 GPa) of the second adhesive AD2 in the first example is the same as a Young's modulus (0.1 GPa) of the second adhesive AD2 in the second example.

That is, in both the first example and the second example, the Young's modulus (0.1 GPa) of the second adhesive AD2 is smaller than the Young's modulus (4.5 GPa or 4.4 GPa) of the first adhesive AD1 and larger than the Young's modulus (0.003 GPa or 0.0004 GPa) of the third adhesive AD3. That is, in both the first example and the second example, the second adhesive AD2 is more compliant than the first adhesive AD1 and stiffer than the third adhesive AD3. In the present example, the Young's modulus of the first adhesive AD1 is desirably 1 to 9 GPa, the Young's modulus of the second adhesive AD2 is 0.01 to 0.9 GPa, and the Young's modulus of the third adhesive AD3 is 0.0001 to 0.9 GPa.

The glass transition temperature differs between the first example and the second example. Specifically, in the first example, the glass transition temperature (40° C.) of the first adhesive AD1 is lower than the glass transition temperature (62° C.) of the second adhesive AD2 and higher than the glass transition temperature (−6° C.) of the third adhesive AD3. Additionally, in the second example, the glass transition temperature (62° C.) of the second adhesive AD2 is lower than the glass transition temperature (150° C.) of the first adhesive AD1 and higher than the glass transition temperature (−65° C.) of the third adhesive AD3.

In the first example, the glass transition temperature (40° C.) of the first adhesive AD1 and the glass transition temperature (−6° C.) of the third adhesive AD3 are within an operating temperature range of the lens driving apparatus 101, and the glass transition temperature (62° C.) of the second adhesive AD2 is higher than the upper limit of the operating temperature range. The operating temperature range of the lens driving apparatus 101 is, for example, −10° C. to 60° C. Additionally, in the second example, the first adhesive AD1, the second adhesive AD2, and the third adhesive AD3 are all outside the operating temperature range. Specifically, in the second example, the glass transition temperature (150° C.) of the first adhesive AD1 and the glass transition temperature (62° C.) of the second adhesive AD2 are higher than the upper limit of the operating temperature range (60° C.), and the glass transition temperature (−65° C.) of the third adhesive AD3 is lower than the lower limit of the operating temperature range (−10° C.). Therefore, in the second example, as long as the lens driving apparatus 101 is used within the operating temperature range, respective stiffnesses of the first adhesive AD1 to the third adhesive AD3 do not change significantly. Therefore, in the second example, compared with the first example, even if an ambient temperature (operating temperature) changes, the characteristics of the piezoelectric driving part PD are less likely to change.

Next, the relation between the frequency of the bending vibration by the piezoelectric driving part PD and the thrust will be described with reference to the graphs of FIGS. 9B and 9C. In both the graphs of FIGS. 9B and 9C, the vertical axis represents the thrust [millinewton (mN)] and the horizontal axis represents the frequency [hertz (Hz)], and the scale is the same. In both the graphs of FIGS. 9B and 9C, the relation when the operating temperature is 22° C. is represented by a solid line, the relation when the operating temperature is 60° C. is represented by a dashed line, and the relation when the operating temperature is −10° C. is represented by a long dashed short dashed line.

In the graph of FIG. 9B illustrating a relation between a frequency of a bending vibration and a thrust by the piezoelectric driving part PD of the first example, at a frequency fa, the thrust at an operating temperature of 22° C. and the thrust at an operating temperature of −10° C. are approximately the same value, n1. Additionally, the difference in thrust between these temperatures and an operating temperature of 60° C. is also approximately the value n1.

Additionally, in the graph of FIG. 9C illustrating a relation between a frequency of a bending vibration and a thrust by the piezoelectric driving part PD of the second example, at the frequency fb, the thrust at the operating temperature of 22° C. and the thrust at the operating temperature of 60° C. are substantially the same value n2, and the difference between the thrust and the thrust at the operating temperature of −10° C. is about the value n1. The value n2 is twice as large as the value n1.

That is, when the operating temperature range is between −10° C. and 60° C., and assuming a configuration in which the bending vibration of the piezoelectric driving part PD is achieved at a single frequency, the piezoelectric driving part PD according to the second example has an effect that a magnitude of a fluctuation of the thrust in response to a change in the operating temperature is about the same as that of the piezoelectric driving part PD according to the first example, and the thrust is larger than that of the piezoelectric driving part PD according to the first example.

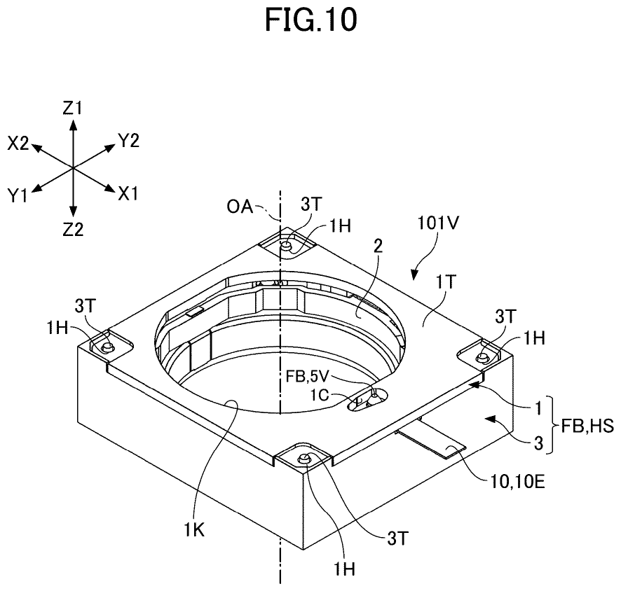

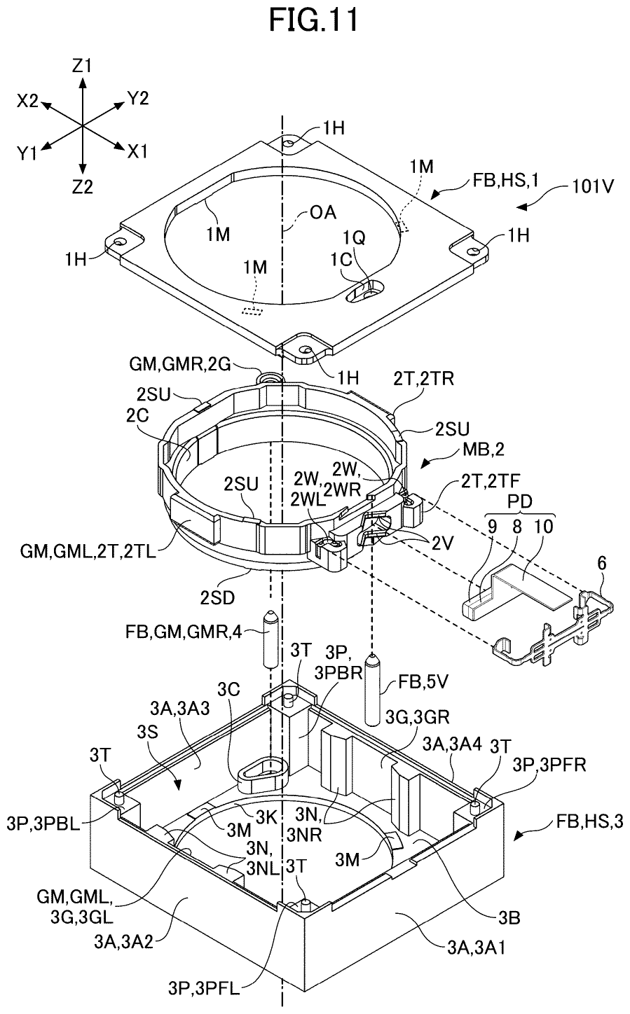

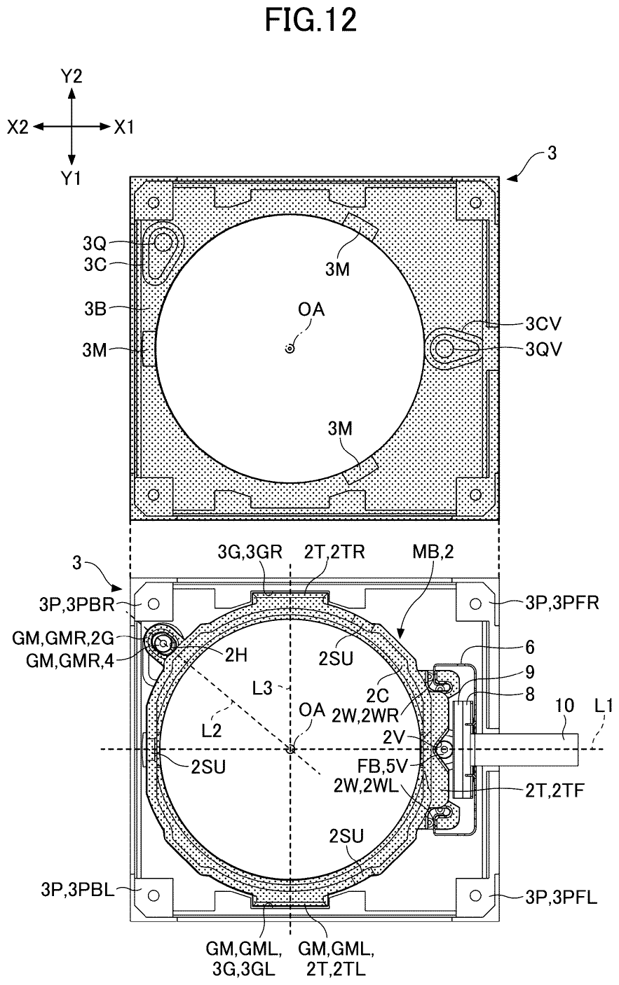

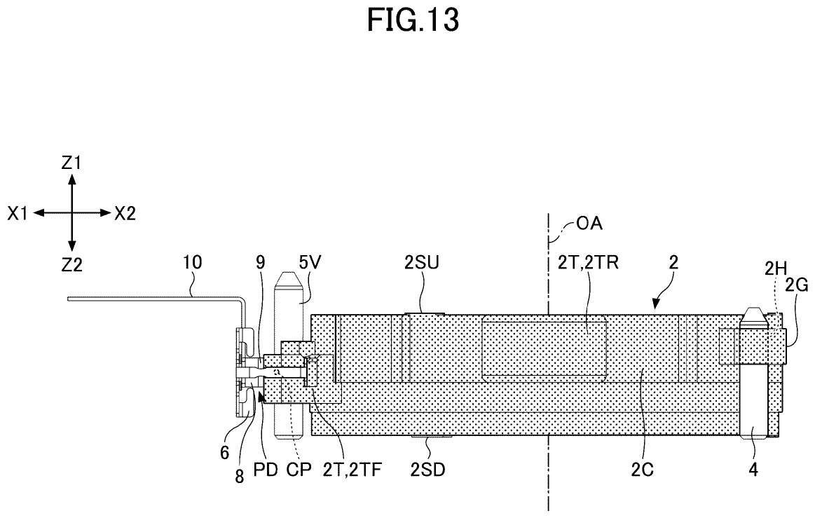

Next, with reference to FIGS. 10 to 13, the lens driving apparatus 101V, which is another configuration example of the lens driving apparatus 101 according to the embodiment of the present disclosure, will be described. FIG. 10 is a perspective view of the lens driving apparatus 101V. FIG. 11 is an exploded perspective view of the lens driving apparatus 101V. FIG. 12 is a top view of the base member 3 constituting the lens driving apparatus 101V. Specifically, the upper drawing of FIG. 12 is a top view of the base member 3 in a state where the lens holding member 2, the guide shaft 4, the receiving member 5V, the biasing member 6, and the piezoelectric driving part PD are not attached, and the lower drawing of FIG. 12 is a top view of the base member 3 in a state where the lens holding member 2, the guide shaft 4, the receiving member 5V, the biasing member 6, and the piezoelectric driving part PD are attached. For clarity, a dot pattern is applied to the base member 3 in the upper drawing of FIG. 12, and a dot pattern is applied to the lens holding member 2 in the lower drawing of FIG. 12. FIG. 13 is a right side view of the lens holding member 2, the guide shaft 4, the receiving member 5V, the biasing member 6, and the piezoelectric driving part PD. Specifically, FIG. 13 shows the positional relation between the lens holding member 2 and the guide shaft 4, the receiving member 5V, the biasing member 6, and the piezoelectric driving part PD when the lens holding member 2 is at its lowest position. For clarity, a dot pattern is applied to the lens holding member 2 in FIG. 13.

The lens driving apparatus 101V is different from the lens driving apparatus 101 in that the piezoelectric driving part PD is provided on the movable member MB (lens holding member 2), whereas in the lens driving apparatus 101, the piezoelectric driving part PD is provided on the fixed member FB (base member 3). Otherwise, the lens driving apparatus 101V is the same as the lens driving apparatus 101. Therefore, in the following description, the common parts will be omitted and the different parts will be described in detail. The same reference numerals are assigned to the same or corresponding members in the lens driving apparatus 101 and the lens driving apparatus 101V.

Specifically, the lens driving apparatus 101V differs from the lens driving apparatus 101 having a receiving member 5 fixed to the lens holding member 2 in that the receiving member 5V is fixed to the base member 3.

The receiving member 5V is a fixed member FB that receives the driving force generated by the piezoelectric driving part PD. In the illustrated example, the receiving member 5V is a tubular member formed of titanium copper and extending in the optical axis direction, and its upper end is fixed to the top plate 1T of the cover member 1, and its lower end is fixed to the bottom plate 3B of the base member 3. Specifically, the upper end of the receiving member 5V is fixed to the cover member 1 with adhesive applied to the adhesive reservoir 1C in a state that it is fitted into the through hole 1Q (see FIG. 11) formed in the inner bottom surface of a recessed adhesive reservoir 1C (see FIG. 10) which opens upward and is provided in the top plate 1T of the cover member 1. The lower end of the receiving member 5V is fixed to the base member 3 with adhesive applied to the adhesive reservoir 3CV in a state that it is fitted into the recess 3QV (see the upper drawing in FIG. 12) formed in the inner bottom surface of the tubular adhesive reservoir 3CV which opens upward and is provided in the bottom plate 3B of the base member 3.

As shown in FIG. 11, a pair of V-shaped grooves 2V are formed in the front protrusion 2TF of the lens holding member 2, and the receiving member 5V is held by the pair of V-shaped grooves 2V and the piezoelectric driving part PD which is biased inward (in a direction approaching the optical axis OA) by the biasing member 6.

The biasing member 6 is configured to bias the piezoelectric driving part PD toward the receiving member 5V. In the example shown in FIG. 11, the biasing member 6 is composed of a plate spring member formed by applying press work to a metal plate made of titanium copper. The metal plate may be made of stainless steel. Both ends of the biasing member 6 are fixed to the front protrusion 2TF of the lens holding member 2. Specifically, the front protrusion 2TF of the lens holding member 2 is formed with a clamping part 2W. The clamping part 2W is a groove configured to hold the fixed part 6A of the biasing member 6, and includes the left clamping part 2WL and the right clamping part 2WR. As described above, the biasing member 6 is configured so that the piezoelectric driving part PD can be pressed toward the receiving member 5V fixed to the lens holding member 2 and fixed to the fixed members FB (cover member 1 and base member 3). The biasing member 6 is configured so that a pair of V-shaped grooves 2V can be pressed toward the receiving member 5V. The biasing member 6 is configured so that it can move in the optical axis direction together with the lens holding member 2.

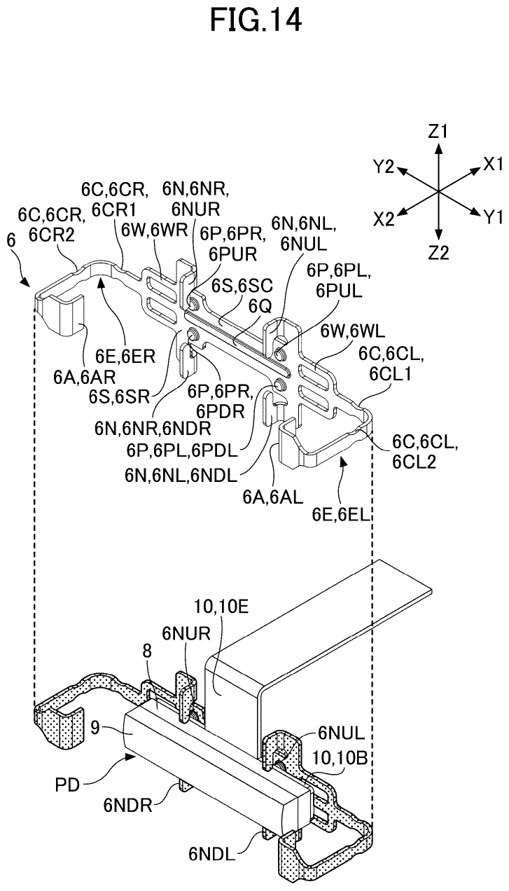

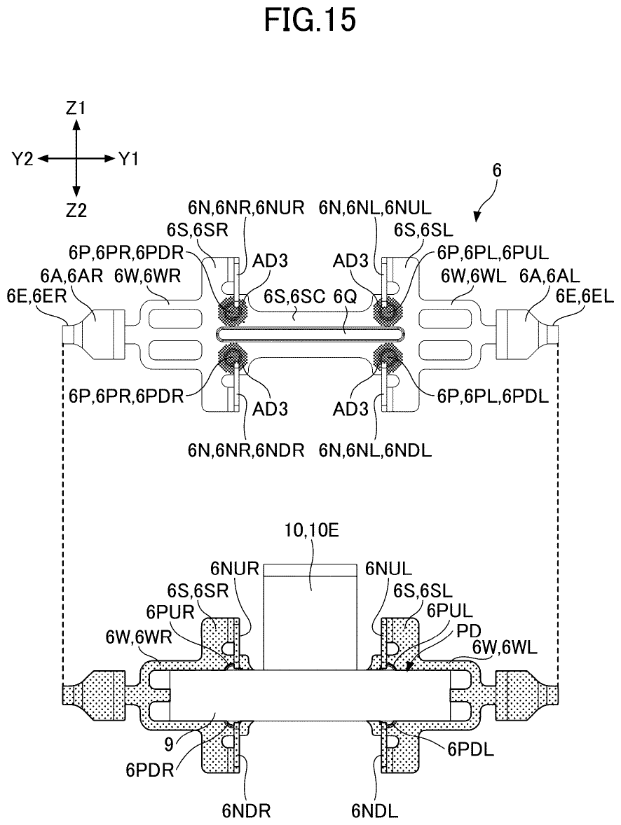

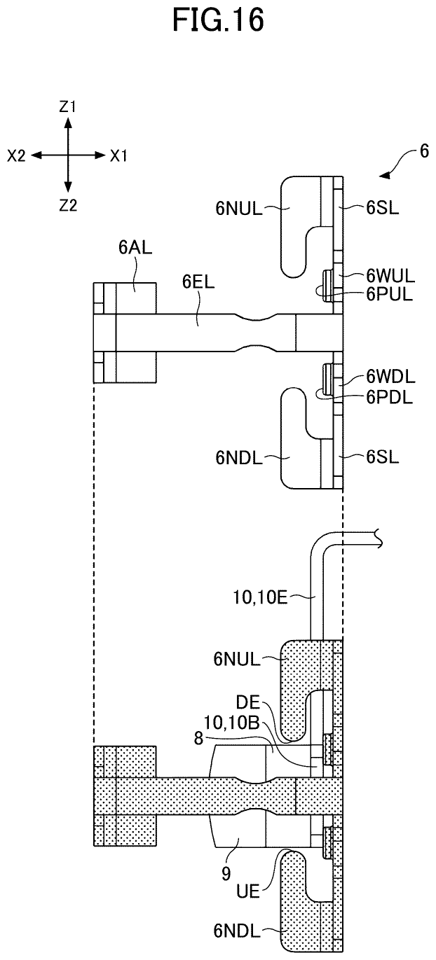

Next, referring to FIGS. 14 to 16, details of the biasing member 6 included in the lens driving apparatus 101V will be described. FIG. 14 is a perspective view of the biasing member 6 and corresponds to FIG. 6. More specifically, the upper drawing of FIG. 14 is a perspective view of the biasing member 6 in a state where the piezoelectric driving part PD is removed. The lower drawing of FIG. 14 is a perspective view of the biasing member 6 in a state where the piezoelectric driving part PD is attached. FIG. 15 is a back view of the biasing member 6 and corresponds to FIG. 7. Specifically, the upper drawing of FIG. 15 is a rear view of the biasing member 6 in a state in which the piezoelectric driving part PD is removed. The lower drawing of FIG. 15 is a rear view of the biasing member 6 in a state in which the piezoelectric driving part PD is attached. FIG. 16 is a left side view of the biasing member 6 and corresponds to FIG. 8. Specifically, the upper drawing of FIG. 16 is a left side view of the biasing member 6 in a state in which the piezoelectric driving part PD is removed. The lower drawing of FIG. 16 is a left side view of the biasing member 6 in a state in which the piezoelectric driving part PD is attached.

The biasing member 6 included in the lens driving apparatus 101V differs from a linear biasing member 6 included in the lens driving apparatus 101 (see the upper drawing of FIG. 6) in that the elastic deformation part 6E is bent in a U-shape as shown in the upper drawing of FIG. 14. The biasing member 6 included in the lens driving apparatus 101V differs from the linear fixed part 6A included in the lens driving apparatus 101 (see the upper drawing of FIG. 6) in that the fixed part 6A is bent in an L-shape as shown in the upper drawing of FIG. 14.

The elastic deformation part 6E of the biasing member 6 included in the lens driving apparatus 101V differs from the elastic deformation part 6E of the biasing member 6 included in the lens driving apparatus 101 in that it has a narrow part 6C. In other respects, the biasing member 6 constituting the lens driving apparatus 101V and the biasing member 6 included in the lens driving apparatus 101 are the same.

The narrow part 6C is used to adjust a pressing load by the biasing member 6 when the biasing member 6 presses the piezoelectric driving part PD and against the receiving member 5V. Typically, the pressing load by the biasing member 6 is adjusted so as to become smaller as the width of the narrow part 6C in the Z-axis direction becomes smaller, and so as to become smaller as a number of the narrow parts 6C increases.

In the illustrated example, the elastic deformation part 6E includes the left elastic deformation part 6EL and the right elastic deformation part 6ER. The left elastic deformation part 6EL includes left narrow parts 6CL, and the right elastic deformation part 6ER includes right narrow parts 6CR. The left narrow parts 6CL include a first left narrow part 6CL1 and a second left narrow part 6CL2, and the right narrow parts 6CR include a first right narrow part 6CR1 and a second right narrow part 6CR2.

Specifically, the first left narrow part 6CL1 is formed by cutting off a part of each of the upper and lower edges of the left elastic deformation part 6EL so that the upper and lower edges of the left elastic deformation part 6EL are vertically symmetric. However, the first left narrow part 6CL1 may be formed by cutting off a part of each of the upper and lower edges of the left elastic deformation part 6EL so that the upper and lower edges of the left elastic deformation part 6EL are vertically asymmetric, or by cutting off a part of either of the upper and lower edges of the left elastic deformation part 6EL. The same applies to the second left narrow part 6CL2, the first right narrow part 6CR1, and the second right narrow part 6CR2. In the illustrated example, the narrow part 6C is achieved by notching using a round punch, and the width of the narrow part 6C in the Z-axis direction is adjusted by changing the diameter of the round punch. Specifically, the width of the narrow part 6C in the Z-axis direction is adjusted so as to is smaller as the diameter of the round punch increases.

Thus, the pressing load by the biasing member 6 can be easily adjusted by forming the narrow part 6C without changing a thickness of the metal plate constituting the biasing member 6. Therefore, adopting the biasing member 6 having the elastic deformation part 6E capable of forming the narrow part 6C has the effect of being able to flexibly absorb variations in the pressing load caused by a manufacturing tolerance and the like of the biasing member 6.

As described above, the lens driving apparatus 101 (or the lens driving apparatus 101V) according to the embodiment of the present disclosure includes a fixed member FB, a lens holding member 2 capable of holding the lens body LS, a piezoelectric driving part PD which is provided on one of the movable member MB including the lens holding member 2 and the fixed member FB and has a piezoelectric element 8 extending in the direction perpendicular to the optical axis direction, a receiving member 5 (or the receiving member 5V) which is provided on the other of the movable member MB and the fixed member FB and in contact with the piezoelectric driving part PD, and a biasing member 6 which biases the piezoelectric driving part PD toward the receiving member 5 (or the receiving member 5V) direction. In the example shown in FIG. 2, the piezoelectric driving part PD is provided on the fixed member FB (base member 3), and in the example shown in FIG. 11, the piezoelectric driving part PD is provided on the movable member MB (lens holding member 2).

In the lens driving apparatus 101 (or the lens driving apparatus 101V), the lens holding member 2 moves in the optical axis direction with respect to the fixed member FB the movement of the piezoelectric element 8. The biasing member 6 is composed of a leaf spring member and has, as shown in the upper drawing of FIG. 6 or the upper drawing of FIG. 14, a fixed part 6A fixed to one of the movable member MB and the fixed member FB, a supporting part 6S supporting the piezoelectric driving part PD, and the elastic deformation part 6E, which is elastically deformable, provided between the fixed part 6A and the supporting part 6S. The supporting part 6S has a plate-shaped base part 6SC facing the piezoelectric driving part PD, and a projection 6P protruding from one surface of the base part 6SC toward the piezoelectric driving part PD. The base part 6SC faces, for example, the surface of the piezoelectric driving part PD opposite to the direction in which the receiving member 5 (or the receiving member 5V) is disposed. The piezoelectric driving part PD is fixed to the projection 6P. This configuration has the effect that the piezoelectric driving part PD can be fixed and biased with a simple structure.

As shown in the upper view of FIG. 7, the projection 6P may be provided at each of the first position PS1 and the second position PS2 which are disposed apart from each other in the extending direction (Y-axis direction) of the piezoelectric element 8. This configuration has the effect that the piezoelectric driving part PD having two nodes ND and moving can be properly fixed.

Each of the first position PS1 and the second position PS2 may have at least two projections 6P arranged in a direction intersecting the extending direction of the piezoelectric element 8. For example, as shown in the upper view of FIG. 7, the first position PS1 has the upper left projection 6PUL and the lower left projection 6PDL arranged in a direction perpendicular to the extending direction (Y-axis direction) of the piezoelectric element 8 (Z-axis direction), and the second position PS2 has the upper right projection 6PUR and the lower right projection 6PDR arranged in a direction perpendicular to the extending direction (Y-axis direction) of the piezoelectric element 8 (Z-axis direction). In this configuration, compared with the configuration in which one projection 6P is provided in each of the first position PS1 and the second position PS2, a wide range in the Z-axis direction on the front surface (X1 direction surface) of the piezoelectric driving part PD is supported by the projection 6P. Therefore, this configuration provides the effect that the fixing of the piezoelectric driving part PD is stabilized.

The base part 6SC may have an elongated protrusion 6Q protruding from one surface. In this case, the protrusion 6Q may be positioned at least between the first position PS1 and the second position PS2 and formed so as to extend in the extending direction (Y-axis direction) of the piezoelectric element 8. In the illustrated example, one elongated rounded rectangular protrusion 6Q is formed in the base part 6SC, but two elongated projections may be formed. In this case, each of the two elongated projections is formed so as to be partially parallel in the Y-axis direction. The same applies to the case where three or more elongated protrusions are formed in the base part 6SC. This configuration has the effect that rigidity of the base part 6SC can be increased. In other words, this configuration has the effect that the base part 6SC can be prevented from being deflected by the bending vibration of the piezoelectric driving part PD, and consequently, a variation of the pressing load caused by the biasing member 6 can be reduced.

As shown in the upper view of FIG. 8, the protrusion 6Q may be formed so that it protrudes from the rear surface (X2 direction surface) which is one surface of the base part 6SC to the rear (X2 direction) which is the same direction as the projection 6P, and the protrusion amount (protrusion height PT2) is smaller than the protrusion amount (protrusion height PT1) of the projection 6P. Further, as shown in the upper view of FIG. 7, the protrusion 6Q may be formed so as to extend continuously from at least the first position PS1 to the second position PS2. In other words, the first position PS1 and the second position PS2 may be included within a formation region of the protrusion 6Q. In the example shown in the upper view of FIG. 7, the protrusion 6Q is formed so that the width WD2, which is the distance between the left end and the right end, is larger than the width WD1, which is the distance between the left bent part 6NL and the right bent 6NR. part This configuration has the effect that the rigidity of the base part 6SC can be increased while thinning the base part 6SC. In other words, this configuration has the effect that the base part 6SC is thin and hard to flex.

As shown in the lower figure of FIG. 8, the piezoelectric driving part PD may have a first edge (upper edge UG) and a second edge (lower edge DG) facing each other in the direction (Z-axis direction), which is perpendicular to the extending direction (Y-axis direction). Further, the projections 6P provided in the first position PS1 and the second position PS2 may have a first portion in contact with the first edge (upper edge UG) and a second portion in contact with the second edge (lower edge DG). Specifically, as shown in the upper diagram of FIG. 7, in the first position PS1, the projections 6P may have an upper left projection 6PUL as the first portion in contact with the first edge (upper edge UG) and a lower left projection 6PDL as the second portion in contact with the second edge (lower edge DG). In the second position PS2, the projections 6P may have an upper right projection 6PUR as the first portion in contact with the first edge (upper edge UG) and a lower-right projection 6PDR as the second portion in contact with the second edge (lower edge DG). As shown in the lower drawing of FIG. 7, the first portions (upper left projection 6PUL and upper right projection 6PUR) may be provided so that a part (upper half) of the first portions protrudes outside (Z1 direction) of the first edge (upper edge UG), and the second portions (lower left projection 6PDL and lower-right projection 6PDR) may be provided so that a part (lower half) of the second portions protrudes outside (Z2 direction) of the second edge (lower edge DG). In this configuration, the first edge (upper edge UG) and the second edge (lower edges DG), which are located apart from each other in the vertical direction (Z-axis direction) that is perpendicular to the extending direction (Y-axis direction) of the moving piezoelectric driving part PD, are supported by a tip surface ES (see the upper drawing of FIG. 8) of the projection 6P. Therefore, this configuration provides the effect that the piezoelectric driving part PD can be stably supported.

As shown in the upper drawing of FIG. 8, the projection 6P is desirably configured so that the tip surface ES is a flat surface and the third adhesive AD3 adheres to the outer peripheral surface CS. In the illustrated example, as shown in the upper drawing of FIG. 7, the third adhesive AD3 is applied so as to adhere to the entire surface of the tip surface ES and to adhere to the entire circumference of the outer peripheral surface CS. However, the third adhesive AD3 may be applied so as to adhere to a part of the tip surface ES or to adhere to a part of the outer peripheral surface CS. This configuration has the effect that a wide area of the front surface of the flexible printed circuit 10 can be prevented from being adhered and fixed to the base part 6SC of the supporting part 6S, and consequently, hindrance of the bending vibration of the piezoelectric driving part PD can be prevented.

Desirably, the first position PS1 and the second position PS2 correspond to the position of the node ND (see FIG. 3) of the piezoelectric element 8 performing the bending vibration. This configuration has the effect that a part of the flexible printed circuit 10 other than the position AP (see FIG. 3) corresponding to the node ND can be prevented from being adhered and fixed to the base part 6SC of the supporting part 6S, and consequently, hindrance of the bending vibration of the piezoelectric driving part PD can be prevented.

As shown in the upper drawing of FIG. 14, the elastic deformation part 6E may have a narrow part 6C for adjusting the load (pressing load) by the biasing member 6. This configuration has the effect that it is easier to adjust the load (pressing load) by the biasing member 6 than when the thickness of the metal plate constituting the biasing member 6 or the length of the elastic deformation part 6E in the extending direction is changed.

As shown in the upper figure of FIG. 6, the elastic deformation part 6E may have wide parts 6W for preventing the torsion of the biasing member 6. The wide parts 6W may be disposed in both directions of the supporting part 6S and include at least two connecting parts. In the illustrated example, the wide parts 6W include a left wide part 6WL disposed on the left of the supporting part 6S and a right wide part 6WR disposed on the right of the supporting part 6S, as shown in the upper figure of FIG. 6. The left wide part 6WL includes three connecting parts (upper left connecting part 6WUL, center left connecting part 6WML, and lower left connecting part 6WDL), and the right wide part 6WR includes three connecting parts (upper right connecting part 6WUR, center right connecting part 6WMR, and lower right connecting part 6WDR). This configuration has the effect of preventing the torsion of the biasing member 6 caused by the bending vibration of the piezoelectric driving part PD. In addition, this configuration has the effect of preventing the rear surface (X2 direction surface) of the base part 6SC from tilting with respect to the YZ plane, and in turn, preventing of the joint part 10B from separating from the tip surface ES of the projection 6P by the bending vibration of the piezoelectric element 8.

The piezoelectric driving part PD may be provided on the fixed member FB. In the example shown in FIG. 2, the piezoelectric driving part PD is fixed through the biasing member 6 by being fitted into a pair of clamping parts 3W formed on each of the left front columnar part 3PFL and the right front columnar part 3PFR of the base member 3. This configuration has the effect of reducing weight of the movable member MB as compared with the case where the piezoelectric driving part PD is provided on the movable member MB.

In addition, in the lens driving apparatus 101 according to the embodiments of the present disclosure, the piezoelectric driving part PD has, as shown in FIG. 3, a contact member 9 fixed to one surface (X2 direction surface) of the piezoelectric element 8 facing the receiving member 5 direction, and a flexible printed circuit 10 fixed to the other surface (X1 direction surface) of the piezoelectric element 8 and formed with a plurality of conductive parts (conductive patterns) conductive to the electrode ED of the piezoelectric element 8. The piezoelectric element 8 and the contact member 9 are fixed with one adhesive (first adhesive AD1), and the flexible printed circuit 10 and the supporting part 6S of the biasing member 6 are fixed with another adhesive (third adhesive AD3). The Young's modulus of the other adhesive (third adhesive AD3) is smaller than that of the one adhesive (first adhesive AD1), as shown in the table in FIG. 9. This configuration has the effect that holding and biasing of the piezoelectric driving part PD can be achieved with a simple structure. In addition, this configuration has the effect that motion of the piezoelectric element 8 can be properly transmitted to the contact member 9 as compared with the case where one adhesive (first adhesive AD1) is more compliant than the other adhesive (third adhesive AD3), because one adhesive (first adhesive AD1) that is disposed on the one surface of the piezoelectric element 8 is stiffer than the other adhesive (third adhesive AD3) that is disposed on the other surface of the piezoelectric element 8.

The piezoelectric element 8 and the flexible printed circuit 10 may be fixed with an anisotropic conductive film as the second adhesive AD2. This configuration has effect that connection between the piezoelectric element 8 and the flexible printed circuit 10 is facilitated.

The Young's modulus of the anisotropic conductive film as the second adhesive AD2 may be smaller than that of the first adhesive AD1. In the first example shown in FIG. 9, the Young's modulus of the anisotropic conductive film as the second adhesive AD2 is 0.1 GPa, and the Young's modulus of the first adhesive AD1 is 4.5 GPa. In the second example shown in FIG. 9, the Young's modulus of the anisotropic conductive film as the second adhesive AD2 is 0.1 GPa, and the Young's modulus of the first adhesive AD1 is 4.4 GPa. In these configurations, the first adhesive AD1 disposed between the piezoelectric element 8 and the contact member 9 in the vibration transmission direction of the piezoelectric element 8 (X2 direction, which is the rear) is stiffer than the second adhesive AD2 disposed between the piezoelectric element 8 and the flexible printed circuit 10 opposite to the piezoelectric element 8 (X1 direction, which is the front). Therefore, this configuration has the effect that the motion of the piezoelectric element 8 can be more appropriately transmitted to the contact member 9 than when the first adhesive AD1 is more compliant than the second adhesive AD2.

The glass transition temperature (glass transition point) of the third adhesive AD3 is desirably −10° C. or less (lower limit of the predetermined operating temperature range), and more desirably −20° C. or less. In the second embodiment shown in FIG. 9, the glass transition temperature of the third adhesive AD3 is about −65° C. In this case, since the predetermined operating temperature range, which is the temperature range of the environment in which a device such as a smartphone mounted with the camera module CM is assumed to be normally used, is higher than the glass transition temperature of the third adhesive AD3, the third adhesive AD3 becomes more compliant than when the temperature of the environment is lower than the glass transition temperature. Therefore, as long as the device is used within the predetermined operating temperature range, the characteristics of the piezoelectric driving part PD such as the thrust generated by the piezoelectric driving part PD do not change suddenly. This is because the temperature of the third adhesive AD3 does not fall below the glass transition temperature and the third adhesive AD3 does not become stiff. Therefore, this configuration provides the effect that vibration such as motion circular of the piezoelectric element 8 can be efficiently transmitted to the contact member 9 direction.

Desirably, the glass transition temperature of the anisotropic conductive film as the second adhesive AD2 is higher than that of the third adhesive AD3. Desirably, the glass transition temperature of the first adhesive AD1 is 60 degrees (upper limit of the operating temperature range) or higher than that of the anisotropic conductive film as the second adhesive AD2. In the second embodiment shown in FIG. 9, the glass transition temperature of the first adhesive AD1 is 150° C., the glass transition temperature of the second adhesive AD2 is 62° C., and the glass transition temperature of the third adhesive AD3 is −65° C. That is, the glass transition temperature of the second adhesive AD2 (62° C.) is higher than that of the third adhesive AD3 (−65° C.). The glass transition temperature of the first adhesive AD1 (150° C.) is higher than the upper limit of the operating temperature range (60° C.) and higher than that of the anisotropic conductive film as the second adhesive AD2 (62° C.). This configuration can prevent the temperature of the first adhesive AD1 from exceeding the glass transition temperature and the first adhesive AD1 from becoming compliant as long as the device is used within the predetermined operating temperature range. Therefore, this configuration has the effect that vibrations such as circular motion of the piezoelectric element 8 can be efficiently transmitted to the contact member 9 direction.

Desirably, the glass transition temperature of the anisotropic conductive film as the second adhesive AD2 is not less than the upper limit (60° C.) of the operating temperature range. In the example shown in FIG. 9, the glass transition temperature of the anisotropic conductive film as the second adhesive AD2 is 62° C., which is higher than the upper limit (60° C.) of the operating temperature range. This configuration can prevent the temperature of the second adhesive AD2 from exceeding the glass transition temperature and the second adhesive AD2 from becoming compliant as long as the device is used within the predetermined operating temperature range. Therefore, this configuration has the effect that vibrations such as circular motion of the piezoelectric element 8 can be efficiently transmitted to the contact member 9 direction.

As shown in FIG. 8, the supporting part 6S of the biasing member 6 may have a plate-shaped base part 6SC opposed to the piezoelectric driving part PD and a portion (projection 6P) protruding from the base part 6SC toward the piezoelectric driving part PD direction. The flexible printed circuit 10 and its protruding portion (projection 6P) may be fixed with the third adhesive AD3 (see the upper drawing in FIG. 7). This configuration has the effect that the movement of the piezoelectric element 8 can be prevented by the supporting part 6S (base part 6SC) because a gap corresponding to the protrusion height PT1 of the protruding portion (projection 6P) is formed between the base part 6SC and the flexible printed circuit 10. In the illustrated example, the portion protruding from the base part 6SC toward the piezoelectric driving part PD direction is a projection 6P having a circular end surface formed by drawing, doweling, or semi-punching, but it may be a portion formed by bending (a folded piece bent in an L-shape) such as a bent part 6N. In this case, the biasing member 6 may be configured such that, for example, each rectangular end face of the pair of bent pieces is in contact with the position AP (see FIG. 3) corresponding to the node ND in the joint part 10B of the flexible printed circuit 10, and is adhered and fixed to the joint part 10B with the third adhesive AD3.

The above described preferred embodiments have been described in detail. However, the present invention is not limited to these embodiments, but various variations and modifications may be made without departing from the scope of the present invention. Each of the features described with reference to the above-described embodiments may be appropriately combined as long as they are not technically inconsistent.

For example, in the lens driving apparatus 101 (or the lens driving apparatus 101V) in the above-described embodiments, the lens holding member 2 moves in the optical axis direction relative to the fixed member FB by the movement of the piezoelectric element 8. However, the moving direction of the lens holding member 2 relative to the fixed member FB is 10 not limited to the optical axis direction and may be a direction perpendicular to the optical axis direction.

What is claimed is:

1. A lens driving apparatus comprising:
a fixed member;
a lens holding member capable of holding a lens body;
a piezoelectric driving part provided on a first member from among a movable member including the lens holding member and the fixed member, and having a piezoelectric element extending in a direction perpendicular to an optical axis direction;
a receiving member which is provided on a second member from among the movable member and the fixed member, and configured to be in contact with the piezoelectric driving part; and
a biasing member configured to bias the piezoelectric driving part in a direction of the receiving member,
wherein the lens holding member is configured to move relative to the fixed member by movement of the piezoelectric element,
wherein the biasing member is composed of a leaf spring member, and includes a fixed part fixed to the first member from among the movable member and the fixed member, a supporting part configured to support the piezoelectric driving part, and an elastic deformation part that is capable of elastically deforming and provided between the fixed part and the supporting part,
wherein the piezoelectric driving part includes a contact member fixed to one surface of the piezoelectric element facing the receiving member, and a flexible printed circuit fixed to another surface of the piezoelectric element,
wherein the piezoelectric element and the contact member are fixed with one adhesive,
wherein the flexible printed circuit and the supporting part are fixed with another adhesive, and
wherein a Young's modulus of the another adhesive is smaller than a Young's modulus of the one adhesive.

2. The lens driving apparatus according to claim 1, wherein the piezoelectric element and the flexible printed circuit are fixed via an anisotropic conductive film.

3. The lens driving apparatus according to claim 2, wherein a Young's modulus of the anisotropic conductive film is smaller than the Young's modulus of the one adhesive.

4. The lens driving apparatus according to claim 1, wherein a glass transition temperature of the another adhesive is −10° C. or less.

5. The lens driving apparatus according to claim 2, wherein a glass transition temperature of the anisotropic conductive film is higher than a glass transition temperature of the another adhesive, and a glass transition temperature of the one adhesive is 60° C. or more and higher than the glass transition temperature of the anisotropic conductive film.

6. The lens driving apparatus according to claim 5, wherein the glass transition temperature of the anisotropic conductive film is 60° C. or more.

7. The lens driving apparatus according to claim 5, wherein the glass transition temperature of the another adhesive is −10° C. or less.

8. The lens driving apparatus according to claim 4, wherein the supporting part has a base part that is plate shaped and opposite to the piezoelectric driving part at a distance from the piezoelectric driving part, and a portion protruding from the base part toward the piezoelectric driving part, and the flexible printed circuit and the portion are fixed with the another adhesive.

9. A camera module comprising:
the lens driving apparatus of claim 1;
a lens body held by the lens holding member; and
an imaging sensor arranged so as to face the lens body.
